(19) United States
(12) Patent Application Publication
(10) Pub. No.: US 2014/0252193 A1
(43) Pub. Date: Sep. 11, 2014

(54) DEVICE AND METHOD FOR SUPPORTING A MELON OR OTHER FRUIT IN AN UPRIGHT POSITION

(71) Applicants: Deborah Lou Creech, Cary, NC (US); Charles Noel Creech, JR., Cary, NC (US)

(72) Inventors: Deborah Lou Creech, Cary, NC (US); Charles Noel Creech, JR., Cary, NC (US)

(21) Appl. No.: 13/792,644

(22) Filed: Mar. 11, 2013

(51) Int. Cl. A47J 43/00; F16M 13/00

(52) U.S. Cl. CPC A47J 43/00; F16M 13/00
USPC 248/346.5; 83/13

(57) ABSTRACT

A device for elevating and securing a melon is provided. The device includes a ring defining a height, and three support members extending from an upper facing surface of the ring in an equally spaced-apart arrangement. A related method for supporting and elevating a melon using the device is provided herein.

### TECHNICAL FIELD

This disclosure is directed towards a device and method for supporting a melon or other fruit in an upright position, and more particularly, towards a device and method for supporting a melon in which the center of gravity of the melon is kept sufficiently low, while the [symbol] .

### BACKGROUND

This disclosure is directed to the problem of securing a cut or half of watermelon in the refrigerator or on a cutting surface without spilling the melon juice and contents of the melon. It also relates to the problem of chilling an uncut or whole melon in the refrigerator to keep it from rolling or tipping, or to secure a melon on any flat surface to keep it from rolling or tipping.

Most persons have dealt with the problem of securely holding a melon upright in the refrigerator or leaving a melon on a support surface. In this instance in which the melon is placed in a refrigerator, most persons address this issue by securing a melon between other objects found in the refrigerator. In the instance in which the melon is left on a support surface, the round shape of the melon makes it prone to rolling away on the support surface.

These and other issues associated with cutting, storing, or otherwise handling a melon have not been appropriately addressed before. The disclosure directed herein is directed to remedying the problems associated with cutting, storing, and otherwise handling the melon.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Disclosed herein is a device for elevating and securing a melon. The device includes a ring defining a height and three support members extending from an upper facing surface of the ring in an equally spaced-apart arrangement.

According to one or more embodiments, the three support members define a generally arcuate upper facing surface.

According to one or more embodiments, the support members generally taper outwardly so that successive devices can be nestably stacked together.

According to one or more embodiments, each of the support members have a generally decreasing thickness so that successive devices can be nestably stacked together.

According to one or more embodiments, a bottom facing surface of the ring defines a frictional surface thereon.

According to one or more embodiments, the spacing between adjacent edges of adjacent support members is about one half of the circumferential length of each support member.

According to one or more embodiments, a height of the ring is about the same height of the support members.

According to one or more embodiments, a method is provided. The method includes providing a device that includes a ring having a thickness and three support members extending from the ring in an equally spaced-apart arrangement and placing a melon into engagement with the three support members such that a bottom facing portion of the melon extends below a top surface of the ring and the melon is generally positioned centrally in the device.

According to one or more embodiments, a device for elevating and securing a melon is provided. The device includes a ring defining a height and a bottom facing surface that defines a textured surface for providing increased frictional resistance and three support members extending from an upper facing surface of the ring in an equally spaced-apart arrangement. Each of the support members have a generally decreasing thickness so that successive devices can be nestably stacked together

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings:

FIG. 1 illustrates side view of a device for elevating and supporting a melon according to one or more embodiments described herein;

FIG. 2 illustrates a side view of a device for elevating and supporting a melon in which unexposed surfaces are shown in broken lines according to one or more embodiments described herein;

FIG. 3 illustrates a sectional view of a device for elevating and supporting a melon according to one or more embodiments described herein;

FIG. 4 illustrates a top view of a device for elevating and supporting a melon according to one or more embodiments described herein;

FIG. 5 illustrates a bottom view of a device for elevating and supporting a melon according to one or more embodiments described herein;

FIG. 6 illustrates a side view of a device for elevating and supporting a melon in which a melon is shown installed thereabout in broken lines according to one or more embodiments described herein;

FIG. 7 illustrates a front view of a device for elevating and supporting a melon in which a melon is shown installed thereabout according to one or more embodiments disclosed herein;

FIG. 8 illustrates a side view of a device for elevating and supporting a melon in which a melon is shown being cut according to one or more embodiments disclosed herein;

FIG. 9 illustrates a front view of a device for elevating and supporting a melon in which fruit is being spooned from a melon according to one or more embodiments disclosed herein;

FIG. 10 illustrates a front view of a device for elevating and supporting a melon in which the melon is engaged with the melon is a refrigerator according to one or more embodiments disclosed herein;

FIG. 11 illustrates a front view of a device disclosed herein engaged with a bowl according to one or more embodiments disclosed herein; and

FIGS. 12 through 14 illustrate various views of an alternate embodiment disclosed herein.

### DETAILED DESCRIPTION

The presently disclosed invention is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies.

The one or more devices disclosed herein include a circular ring with an upper surface defining and/or including three upward protruding rises (modes, buttons, slanted humps, arches, points, pegs, angled, pegs, tapered arches, or similar) that are spaced a sufficient distance from each other to prevent a melon from tipping or falling when placed on top of the rises. The rises sit on the same plane and support the melon at a sufficient elevation above the surface where the stand is placed. The lower end is flat in order to make even contact with the level surface where the stand is placed and will provide the melon clearance from the surface where the stand is placed.

In view of the foregoing, one or more main objects of the one or more embodiments disclosed herein is to provide a solution to stabilizing and securing a melon from rolling, rotating, tipping, and spilling its contents while being stored in a refrigerator, having fruit spooned therefrom, or cutting of the melon.

Still another object of the invention was to provide a melon stand solution that may be mass-produced at a relatively low cost, making it affordable to millions of households.

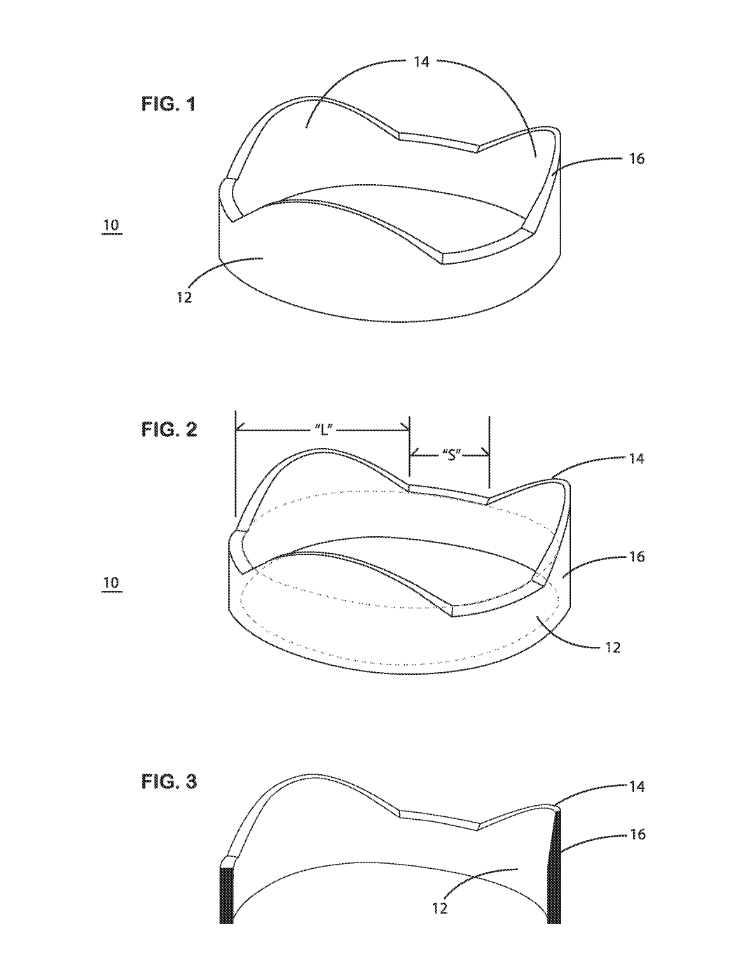

FIGS. 1 through 3 illustrate a device 10 for elevating and securing a melon. The device 10 may include a ring 12. Ring 12 may be made from any appropriate material, including a polymer or plastic based material, a metal, a wood, or a composite. The ring 12 may also define one or more surfaces for having advertising indicia printed thereon. The ring 12 may have any appropriately configured diameter and thickness, however, in one or more embodiments, it has been determined that a ring of about 4.25 inches in diameter and about three eighths of an inch in thickness provides exceptional support to the melon.

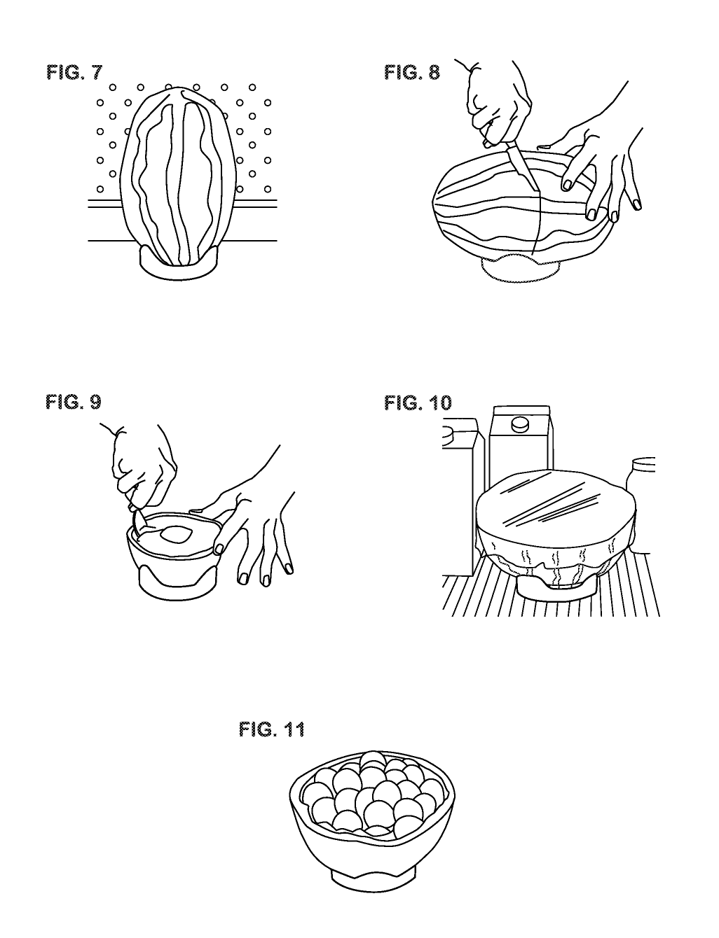

The ring 12 may further define a height. The height may be any appropriately selected height, but in advantageous embodiments, height of the spacer is sufficient to elevate a melon (to be illustrated more closely in FIGS. 7 through 11) in such a way that the center of gravity of the melon is sufficiently low that the melon does not easily tip over. In one or more embodiments, the height of ring 12 may be about three quarters of one inch. The ring 12 may further define three support members 14 that extend from an upper facing surface of the ring 12 in an equally spaced-apart arrangement. The support members 14 do not have to be equally spaced-apart in all embodiments. In one or more embodiments, more or less support members 14 may be employed. Support members 14 are shown as generally arcuate shaped shoulders, but any appropriately configured shape may be employed. Support members 14 may be integrally formed with ring 12, or may be separately formed and attached to ring 12 by any appropriate manner, such as, for example, glue, pins, screws, or other fasteners.

In one or more embodiments, the spacing “S” between adjacent edges of adjacent support members 14 is about one half of the circumferential length “L” of each support member. The spacing “S” between adjacent edges may define a generally flat upper surface as illustrated.

Each of the support members 14 may generally taper outwardly so that successive devices can be nestably stacked together. Additionally, each of the support members 14 may have a generally decreasing thickness so that successive devices can be nestably stacked together. This is illustrated best in FIG. 4 in which upper facing surfaces 16 are shown having a more narrow dimension than base or ring 12. In one or more embodiments, a bottom facing surface of the ring defines a frictional surface 22 thereon such as that which is illustrated in FIG. 5. The frictional surface 22 may define or more additional layers applied to the ring 12 or may include texturing applied directly to the ring 12 such as, for example, sanding or other texturing of the bottom surface of ring 12.

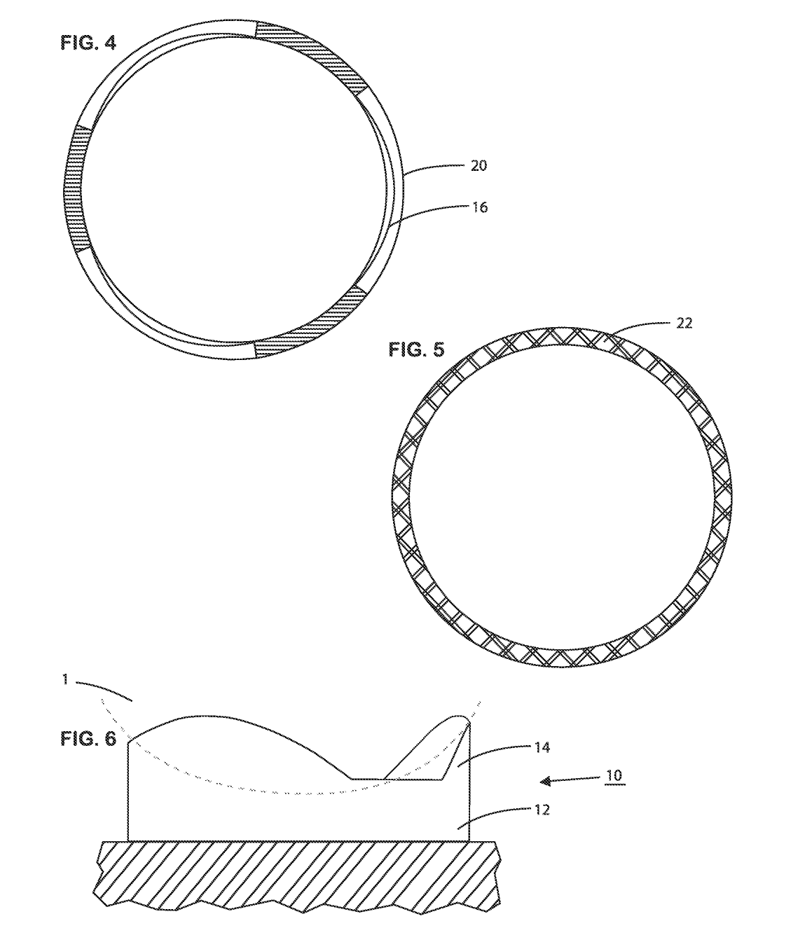

One or more methods for elevating and supporting a melon are disclosed herein. The one or more methods may include using one or more of the devices 10 disclosed herein. The one or more methods may include placing a melon 1 into engagement with the three support members 14 such that a bottom facing portion of the melon extends below a top surface of the ring 12 and the melon is generally positioned centrally in the device 10. This is illustrated clearly in FIG. 6, as well as FIGS. 7 through 9. As illustrated in FIG. 7, a watermelon may be positioned standing upright in device 10. As illustrated in FIG. 8, a watermelon may be positioned extending horizontally lengthwise in which the watermelon is advantageously positioned for being cut. As illustrated in FIG. 9, a watermelon may be positioned such that fruit may be spooned therefrom. As illustrated in FIG. 10, a watermelon half may be stored in a refrigerator or the like by engaging with device 10. As illustrated in FIG. 10, device 10 may be used for storing a watermelon half to which fruit is served from.

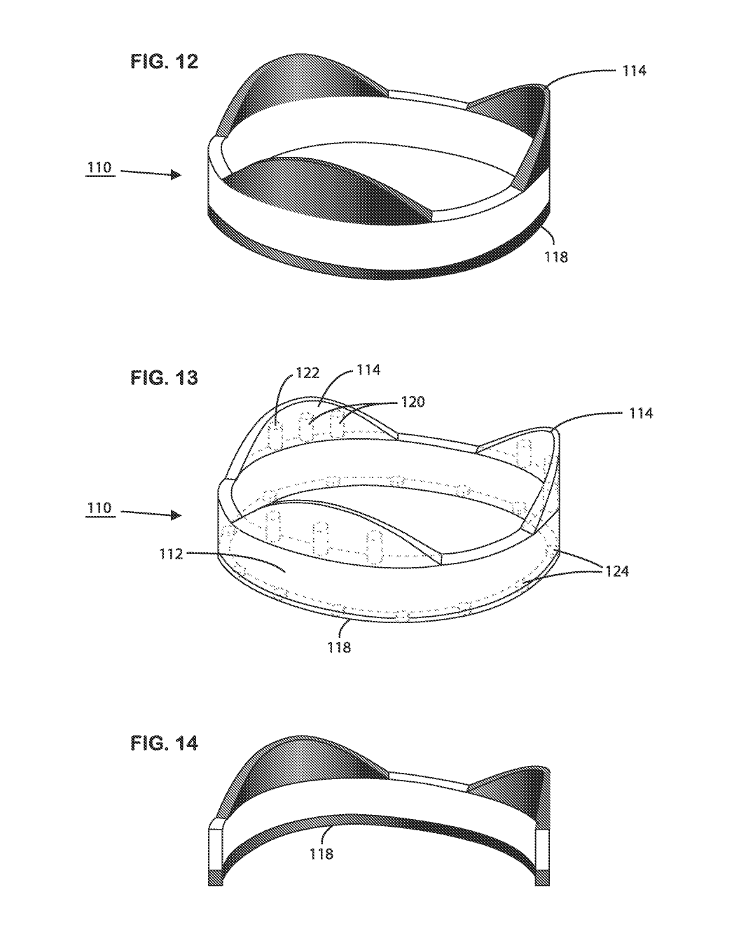

One or more additional embodiments of a device are illustrated in FIGS. 12 through 14. The device 110 may include a plurality of overmolded portions about support members 114 that have a grip or other resilient feature for providing a resiliency and/or flexibility to the contact point between the support members 114 and melon. The device 110 may be formed in sections, with support members 114 engaged with ring 112 via pins 120 extending from ring 112 into corresponding recesses 122 in support member 114. Base portion 118 may also be received by ring 112 by the interaction of pegs 124. Base portion 118 may define one or more textural features for providing flexibility and increased frictional resistance to base portion 118 and the entire device assembly 110.

The devices 10 and 110 disclosed herein are appropriate for being cleaned in a dishwasher. Additionally, devices 10 and 110 provide increased safety for a user compared to attempting to cut a melon on a standard support surface.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A device for elevating and securing a melon, comprising:
a ring defining a height; and
three support members extending from an upper facing surface of the ring in an equally spaced-apart arrangement.

2. The device according to claim 1, wherein the three support members define a generally arcuate upper facing surface.

3. The device according to claim 1, wherein the support members generally taper outwardly so that successive devices can be nestably stacked together.

4. The device according to claim 1, wherein each of the support members have a generally decreasing thickness so that successive devices can be nestably stacked together.

5. The device according to claim 1, wherein a bottom facing surface of the ring defines a frictional surface thereon.

6. The device according to claim 1, wherein the spacing between adjacent edges of adjacent support members is about one half of the circumferential length of each support member.

7. The device according to claim 1, wherein a height of the ring is about the same height of the support members.

8. A method comprising:
providing a device that includes a ring having a thickness and three support members extending from the ring in an equally spaced-apart arrangement; and
placing a melon into engagement with the three support members such that a bottom facing portion of the melon extends below a top surface of the ring and the melon is generally positioned centrally in the device.

9. The method according to claim 8, wherein the three support members define a generally arcuate upper facing surface.

10. The method according to claim 8, wherein the support members generally taper outwardly so that successive devices can be nestably stacked together.

11. The method according to claim 8, wherein the support members have a generally decreasing thickness so that successive devices can be nestably stacked together.

12. The method according to claim 8, wherein a bottom facing surface of the ring defines a frictional surface thereon.

13. The method according to claim 8, wherein the spacing between adjacent edges of adjacent support members is about one half of the circumferential length of each support member.

14. The method according to claim 8, further comprising cutting the melon.

15. A device for elevating and securing a melon, comprising:
a ring defining a height and a bottom facing surface that defines a textured surface for providing increased frictional resistance; and
three support members extending from an upper facing surface of the ring in an equally spaced-apart arrangement,
wherein each of the support members have a generally decreasing thickness so that successive devices can be nestably stacked together

16. The device according to claim 15, wherein the three support members define a generally arcuate upper facing surface.

17. The device according to claim 15, wherein the spacing between adjacent edges of adjacent support members is about one half of the circumferential length of each support member.
